(19) United States
(12) Patent Application Publication
(10) Pub. No.: US 2007/0048043 A1
(43) Pub. Date: Mar. 1, 2007

(54) Fixing apparatus of image forming apparatus

(75) Inventor: Woong-jae Chang, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/434,858

(22) Filed: May 17, 2006

(30) Foreign Application Priority Data
Aug. 23, 2005 (KR) 2005-77539

(51) Int. Cl. G03G 15/20

(52) U.S. Cl. 399/329

(57) ABSTRACT

A fixing apparatus for an image forming apparatus including a fixing roller, a fixing belt moving endlessly while being in contact with an outer surface of the fixing roller, and an anti-serpentine unit selectively in contact with both lateral outer edges of the fixing belt, which biases the fixing belt toward a center of the fixing roller to prevent serpentine movement of the belt. Therefore, it is possible to address serpentine movement of the fixing belt without causing damage to the fixing belt.

### CROSS-REFERENCE TO RELATED APPLICATION

This application claims benefit under 35 U.S.C. § 119(a) of Korean Patent Application No. 2005-77539, filed Aug. 23, 2005, the entire contents of which are incorporated herein by reference.

### BACKGROUND OF THE INVENTION

1. Field of the Invention

Aspects of the present invention relate to an image forming apparatus, and more particularly, to a fixing apparatus for an image forming apparatus using a fixing belt.

2. Description of the Related Art

Generally, an image forming apparatus such as a laser printer, a copier, a scanner, a multi-function printer, a fax machine, and so on includes a fixing apparatus for fusing a developing agent transferred to a surface of a recording medium by a well-known transfer roller and adhering the developing agent to the recording medium. Such a fixing apparatus includes a pair of fixing rollers rotating in close contact with each other, and employs a fixing belt moving endlessly while being supported by at least one fixing roller and a support roller.

However, the fixing apparatus of the image forming apparatus using the above fixing belt has a problem, specifically, that the fixing belt moves in a lateral direction with reference to its running direction, i.e., serpentine movement of the fixing belt, or slippage. This serpentine movement, or slippage, causes the fixing belt to deviate towards the ends of the fixing roller along the rotation axis of the fixing belt as the fixing belt rotates.

In order to solve this and/or other problems, a fixing apparatus for an image forming apparatus including an anti-serpentine threshold has been developed. The conventional fixing apparatus for the image forming apparatus is provided with an anti-serpentine threshold at both sides of the roller to prevent the serpentine movement of the fixing belt by confining the lateral movement of the fixing belt using the anti-serpentine threshold when the fixing belt serpentines.

However, in the image forming apparatus as described above, when edges of the fixing belt are in contact with the anti-serpentine threshold, the edges of the fixing belt are subjected to concentrated stress by a strong resistance generated at the edges of the fixing belt. This concentrated stress in turn causes damage to the fixing belt.

### SUMMARY OF THE INVENTION

The present invention, therefore, solves the aforementioned and/or other problems associated with conventional devices by providing a fixing apparatus for an image forming apparatus capable of correcting serpentine movement of the fixing belt without damaging the fixing belt.

It is another aspect of the present invention to provide a fixing apparatus for an image forming apparatus capable of removing contaminants of the fixing belt.

Additional aspects and/or advantages of the invention will be set forth in part in the description which follows and, in part, will be obvious from the description, or may be learned by practice of the invention.

In order to achieve the above and/or other aspects, there is provided a fixing apparatus for an image forming apparatus including: a fixing roller; a fixing belt in contact with an outer surface of the fixing roller to be rotated in an endless manner; and an anti-serpentine unit selectively in contact with both lateral outer edges of the fixing belt, which biases the fixing belt toward a center of the roller to correct serpentine movement of the fixing belt.

In this process, the anti-serpentine unit includes a guide roller rotated together with the fixing belt in contact with the outer surface thereof, and provided with guide parts at both ends of the guide roller. Each guide part is shaped to have a diameter that increases away from the center of the guide roller so that both edges of the fixing belt become extended when the fixing belt experiences slippage.

In addition, the guide parts preferably have a predetermined radius of curvature or a predetermined angle of slope.

In accordance with another embodiment of the present invention, the fixing apparatus for an image forming apparatus further includes a second fixing roller rotated in close contact with the fixing roller, and a support roller disposed apart from the second fixing roller by a certain interval to support the endless rotation of the fixing belt together with the second fixing roller.

In this process, preferably, the fixing roller is a heat roller, and the second fixing roller is a pressure roller. However, the present invention can also be used with many other types of rollers found within image forming devices.

In addition, the guide roller has a cleaning function of removing contaminants on the fixing belt.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a fixing apparatus of an image forming apparatus in accordance with an embodiment of the present invention;

FIG. 2 is a front view of a guide roller as a main component of the present invention;

FIGS. 3A and 3B are views for illustrating a serpentine correction theory of a fixing belt using the guide roller; and

FIG. 4 is a view for illustrating a preferable position of the guide roller and the fixing belt.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

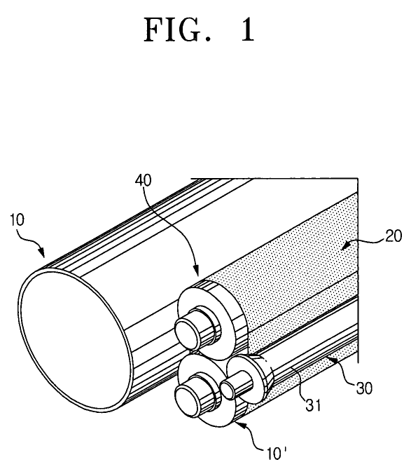

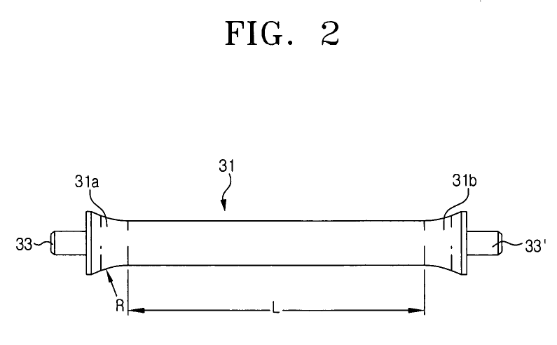

FIG. 1 is a perspective view of a fixing apparatus of an image forming apparatus in accordance with an embodiment of the present invention, and FIG. 2 is a front view of a guide roller of FIG. 1.

As shown in FIGS. 1 and 2, the fixing apparatus for an image forming apparatus in accordance with an embodiment of the present invention includes a fixing roller 10, a fixing belt 20, and an anti-serpentine unit 30.

The fixing roller 10 is a cylindrical roller installed to press toner, which is transferred to a surface of a recording medium by using a well-known transfer roller (not shown), so that the toner is adhered to the recording medium in a fusing manner. The fixing roller 10 rotates while it is in close contact with a second fixing roller 10′ positioned in parallel with the fixing roller 10. Preferably, the fixing roller 10 is a heat roller, and the second fixing roller 10′ is a pressure roller. In order to support the fixing belt 20 so that the fixing belt 20 moves endlessly according to the rotational movement of the second fixing roller 10′, a support roller 40 is disposed apart from the second fixing roller 10′ by a certain distance.

The fixing belt 20 moves in contact with an outer surface of the fixing roller 10 in an endless manner.

The anti-serpentine unit 30 is selectively in contact with both lateral outer edges of the fixing belt 20 and biases the fixing belt 20 toward a center of the fixing roller 10 to correct serpentine movement of the fixing belt 20. The anti-serpentine unit 30 is a guide roller 31 rotating in external contact with the fixing belt 20 and having guide parts 31a and 31b at both ends of the guide roller 31 where each guide part 31a and 31b, being in contact with the lateral edges of the fixing belt 20, is shaped to have an increasing diameter so that both edges of the fixing belt 20 become extended when the fixing belt serpentines. In addition, each of the guide parts 31a and 31b is formed to have a curved surface (guide surface) having a predetermined curvature radius R. The curved surface is provided to correct the serpentine movement of the fixing belt 20 by moving the fixing belt 20 toward a center of the roller when the fixing belt 20 is in contact with the curved surface. While not shown, the guide parts 31a and 31b may be formed to have a predetermined angle of slope.

In the embodiment, while the guide roller 31 is integrally formed with the guide parts 31a and 31b at both ends thereof, the guide parts 31a and 31b may also be fastened to both ends of the guide roller 31. The guide parts can therefore be removed and replaced with different guide parts of different size and shape depending on the needs of the user and the type of image forming apparatus.

Preferably, the guide roller 31 has a cleaning function of removing contaminants such as fine particles, residual toner, foreign matters, and other contaminants attached to a surface of the fixing belt 20 while the guide roller 31 rotates in close contact with the fixing belt 20.

Reference numerals 33 and 33′ designate a rotational shaft of the guide roller 31.

In the fixing apparatus for an image forming apparatus in accordance with an embodiment of the present invention, the fixing roller 10 and the second fixing roller 10′ rotate in close contact with each other, and the fixing belt 20, which is supported by the second fixing roller 10′ and the support roller 40, moves in an endless manner. The fixing belt 20, running according to the rotational movement of the rollers, may also incidentally move in a lateral direction, that is, the perpendicular direction with reference to a running direction of the fixing belt, resulting in serpentine movement of the belt. This lateral direction is along the rotation axis of the fixing belt. At this time, the guide roller 31, rotating in external contact with the fixing belt 20, corrects the serpentine movement of the fixing belt 20 so that the fixing belt 20 can run normally.

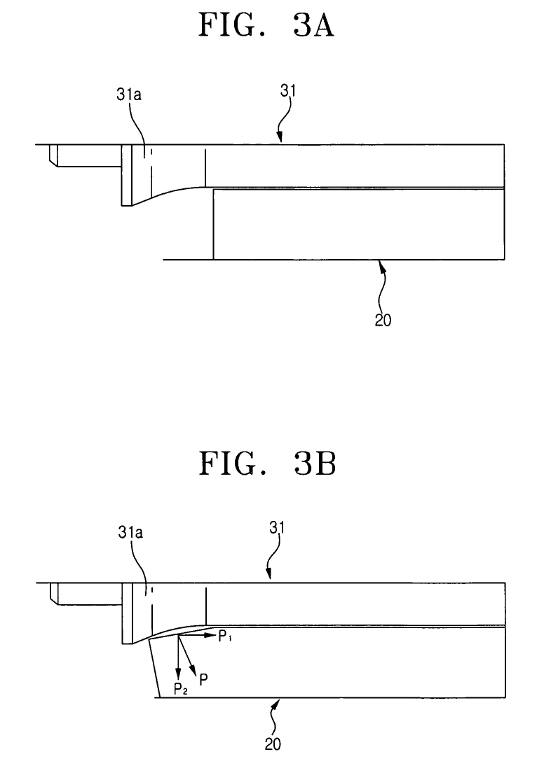

Referring to FIG. 3A, when the edge of the fixing belt 20 is not in contact with the guide part 31a of the guide roller 31 while the fixing belt 20 is running, i.e., the fixing belt 20 is not in serpentine, the fixing belt 20 maintains a normal running state on the guide roller 31.

Referring to FIG. 3B, when a lateral edge of the fixing belt 20 is in contact with the guide part 31a of the guide roller 31 while the fixing belt 20 is running, i.e., the belt serpentines, a perpendicular stress P is generated at the lateral edge of the fixing belt 20 in contact with the curved surface of the guide roller 31. The fixing belt 20 is returned to its normal position toward the center of the roller by an axial component P1 of the stress P, so that the serpentine movement of the fixing belt 20 is corrected. In addition, since the stress for correcting the serpentine movement of the fixing belt 20 is applied not only to lateral edges of the fixing belt 20, but rather is distributed uniformly in a surface of the fixing belt 20, it is possible to prevent the belt from being damaged due to the stress applied to the belt.

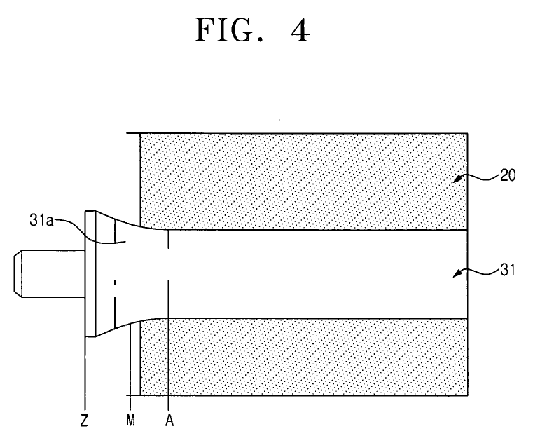

FIG. 4 is a view for illustrating a preferable position of the guide roller and the fixing belt.

As shown in FIG. 4, a preferable position of the fixing belt 20 is a position where the lateral edges of the fixing belt 20 are located inside the center position M of the guide part 31a, starting from a start position A and ending at an end position Z of the guide roller 31. This position both prevents damage to the fixing belt 20 and also improves the running stability of the fixing belt 20.

As can be seen from the foregoing, the fixing apparatus of an image forming apparatus in accordance with the present invention is capable of preventing the serpentine movement of the fixing belt, which may cause damage to the fixing belt, along with removing contaminants on the surface of the fixing belt by controlling the fixing belt using the guide/cleaning roller when the fixing belt is abnormally running.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fixing apparatus for an image forming apparatus, comprising:
a fixing roller;
a fixing belt moving endlessly while being in contact with an outer surface of the fixing roller; and
an anti-serpentine unit selectively in contact with both lateral outer edges of the fixing belt, and biasing the fixing belt toward a center of the fixing roller to correct serpentine movement of the fixing belt.

2. The fixing apparatus for an image forming apparatus according to claim 1, wherein the anti-serpentine unit comprises a guide roller rotating while being in contact with the fixing belt and having guide parts at both ends thereof, wherein each guide part has a diameter which gradually increases in a direction of a corresponding end of the guide roller and is selectively in contact with a corresponding one of the lateral outer edges of the fixing belt according to the serpentine movement of the fixing belt.

3. The fixing apparatus for an image forming apparatus according to claim 2, wherein the guide parts have a curvature with a predetermined radius.

4. The fixing apparatus for an image forming apparatus according to claim 2, wherein the guide parts have a predetermined angle of slope.

5. The fixing apparatus for an image forming apparatus according to claim 2, further comprising:
a second fixing roller rotating in contact with the fixing roller; and
a support roller disposed apart from the second fixing roller by a certain distance, supporting the fixing belt to move endlessly, in a substantially same manner as the second fixing roller.

6. The fixing apparatus for an image forming apparatus according to claim 5, wherein the fixing roller is a heat roller and the second fixing roller is a pressure roller.

7. The fixing apparatus for an image forming apparatus according to claim 2, wherein the guide roller has a cleaning function of removing contaminants on the fixing belt.

8. The fixing apparatus for an image forming apparatus according to claim 2, wherein the guide parts are integrally formed with the guide roller.

9. The fixing apparatus for an image forming apparatus according to claim 2, wherein the guide parts are respectively fastened to both ends of the guide roller.

10. The fixing apparatus for an image forming apparatus according to claim 1, wherein the image forming device is a laser printer, copier, scanner, multi-function printer or fax machine.

11. A fixing apparatus for an image forming apparatus comprising:
a fixing roller;
a fixing belt moving endlessly while being in contact with an outer surface of the fixing roller; and
an anti-serpentine unit selectively in contact with both lateral edges of the fixing belt,
which applies stress to the lateral edges of the fixing belt in a uniform distribution to correct serpentine movement of the fixing belt.

12. The fixing apparatus for an image forming apparatus according to claim 11, wherein the anti-serpentine unit comprises a guide roller rotating while being in contact with the fixing belt and having guide parts at both ends thereof, wherein each guide part has a gradually increasing diameter in a direction of a corresponding end of the guide roller.

13. The fixing apparatus for an image forming apparatus according to claim 12, wherein the guide parts have a curvature with a predetermined radius.

14. The fixing apparatus for an image forming apparatus according to claim 12, wherein the guide parts have a predetermined angle of slope.

15. The fixing apparatus for an image forming apparatus according to claim 12, further comprising:
a second fixing roller rotating in contact with the fixing roller; and
a support roller disposed apart from the second fixing roller by a certain distance for supporting the fixing belt to move endlessly, in a substantially same manner as the second fixing roller.

16. The fixing apparatus for an image forming apparatus according to claim 15, wherein the fixing roller is a heat roller and the second fixing roller is a pressure roller.

17. The fixing apparatus for an image forming apparatus according to claim 12, wherein the guide roller has a cleaning function of removing contaminants on the fixing belt.

18. A device for correcting slippage of a belt rotating around a roller in an image forming apparatus, comprising:
a cylinder positioned near the roller and in contact with the belt, and
end pieces having curved surfaces which are attached to corresponding ends of the cylinder and prevent the belt from slipping off the roller.

19. The device of claim 18, wherein the end pieces have gradually increasing diameters in a direction of a corresponding end of the roller.

20. A fixing apparatus for an image forming apparatus, comprising:
a fixing roller;
a fixing belt moving while being in contact with an outer surface of the fixing roller; and
a slippage correction unit having curved surfaces which selectively contact the fixing belt in response to the fixing belt slipping in either direction along a rotation axis of the fixing belt, and correct for the slippage by biasing the fixing belt toward a center of the fixing belt.
